(19) United States
(12) Patent Application Publication
(10) Pub. No.: US 2022/0108004 A1
(43) Pub. Date: Apr. 7, 2022

(54) TRUSTED EXECUTION ENVIRONMENT (TEE) DETECTION OF SYSTEMIC MALWARE IN A COMPUTING SYSTEM THAT HOSTS THE TEE

(71) Applicant: T-Mobile USA, Inc., Bellevue, WA (US)

(72) Inventors: Shawn David Corey, Kenmore, WA (US); Michael David Bishop, Issaquah, WA (US)

(21) Appl. No.: 16/948,925

(22) Filed: Oct. 6, 2020

(51) Int. Cl. G06F 21/53; G06F 21/56

(52) U.S. Cl. CPC G06F 21/53; G06F 2221/034; G06F 21/566

(57) ABSTRACT

Described herein are techniques for performing a trusted execution environment (TEE) detection of systemic malware in a computing system that hosts the TEE. As described, the techniques may include a TEE obtaining data from one or more subsystems of a computing system that hosts the TEE. The TEE is configured to execute components in isolation from the one or more subsystems of the computing system. Based on the data obtained, the TEE detects systemic malware on the one or more subsystems of the computing system. In response to the detected malware, the TEE reports the detection of malware on the one or more subsystems of the computing system.

### BACKGROUND

Malware is a portmanteau for malicious software. Malware is a collective name for various programs employed by cyberattackers to cause damage, infiltrate, surveil, or otherwise access data, networks, or computers without authorization and/or with harmful intent. Common names of such programs include viruses, worms, ransomware, and spyware.

Malware detection software is a cybersecurity tool that is designed to detect and remove malware on computing systems. Often such software is called anti-virus software. In the on-going battle between the malware developers and the malware detection developers, the front lines involve an escalating series of measures, countermeasures, counter-countermeasures, and so forth.

In this context, cybersecurity forces have introduced hardware-based secure enclaves to address the problem of protecting data while it is being used. Hardware-based secure enclaves may be called trusted execution environments (TEEs) herein.

A TEE is a hardware-based secure, integrity-protected processing environment, consisting of memory and storage capabilities. While in use, the data and the applications of the TEE are entirely protected from outside the hardware-based isolated environment. Indeed, the in-use TEE data and applications are protected from an operating system (OS), a hypervisor, and a root user of a compromised computing system.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 schematically illustrates an example scenario 100 of a computing system hosting a discrete Trusted Execution Environment (TEE) in accordance with the technology described herein.

FIG. 2 schematically illustrates an example scenario 100 of a computing system hosting an integrated TEE in accordance with the technology described herein.

FIG. 3 illustrates an example process TEE detection of systemic malware in a computing system that hosts the TEE in accordance with the technology described herein.

FIG. 4 illustrates another example process TEE detection of systemic malware in a computing system that hosts the TEE in accordance with the technology described herein.

### DETAILED DESCRIPTION

The technology described herein is generally directed towards the detection of systemic malware in computing systems. More particularly, the technology described herein involves the detection of systemic malware in an untrusted computing subsystem of a computing system from an isolated subsystem. More particularly still, the technology described herein involves systemic malware detection that is securely executed within the context of a hardware-based security enclave hosted by a computing system.

The malware detection of the technology described herein is “systemic” because it detects malware located within an untrusted portion of the computing system. More precisely, the systemic malware detection detects malware located in an untrusted subsystem of the computing system. Examples of untrusted subsystems include OS, applications executing on the computing system, a storage subsystem of the computing system, a memory of the computing system, files, a graphics processing subsystem of the computing system, and a baseboard management controller (BMC), and the like.

Examples of hardware-based security enclaves or trusted execution environments (TEEs) suitable to implement the technology described herein includes (but is not limited to): AMD™ Platform Security Processor (PSP), ARM TRUSTZONE™, IBM™ Secure Service Container, IBM™ Secure Execution, INTEL™ Trusted Execution Technology, and INTEL™ Software Guard Extensions (SGX).

A TEE is a tamper-resistant processing environment that runs on a separation kernel, which is a security kernel used to simulate a distributed system. The separation kernel enables the coexistence of different security tiers on the same computing system. A TEE guarantees the authenticity of its applications (e.g., executable instructions), the integrity of the runtime states (e.g., processors' registers, memory, and sensitive input/output), and the confidentiality of its executable instructions, data, and runtime states stored on persistent memory.

Since the systemic malware detection operates in isolation in a TEE, it may be performed independently and out-of-band from an OS of the computing system, which is untrusted. That is, the technology described herein does not need the cooperation or permission of the untrusted central processors or untrusted OS to perform the systemic malware detection. Similarly, systemic malware detection may be updated without the cooperation or permission of the untrusted central processors or untrusted OS.

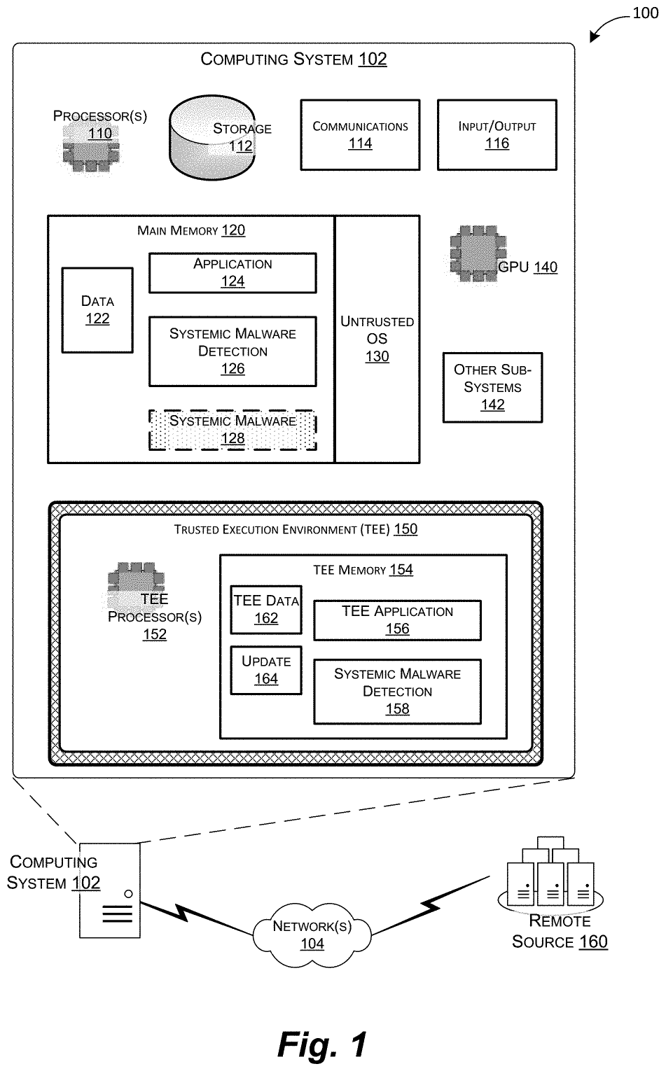

FIG. 1 schematically illustrates an example scenario 100 in accordance with the technology described herein. In particular, the example scenario 100 depicts a computing system 102 that hosts a discrete TEE 150. The example scenario 100 also includes one or more communications networks 104, and a remote source 160.

The computing system 102 is a programmable electronic device that has multiple subsystems that are designed to accept, process, and store data, perform prescribed mathematical and logical operations at high speed, and present, store, or transmit the results of these. Examples of a suitable computing system 102 include (but is not limited to): a computer, a mobile device, a server, a tablet computer, a notebook computer, handheld computer, a workstation, a desktop computer, a laptop, a tablet, user equipment (UE), a network appliance, an e-reader, a wearable computer, a network node, a microcontroller, a smartphone, or another computing device that configured in a manner similar to how the computing system 102 is described herein and is capable of performing the functionalities presented herein.

The one or more communications networks 104 is a collection of interconnected computing devices (i.e., network nodes) that use a set of common communication protocols over digital interconnections to share resources or services located on or provided by the network nodes. The interconnections between nodes are formed from one or more of a broad spectrum of telecommunication network technologies, based on physically wired, optical, and wireless radio-frequency methods that may be arranged in a variety of network topologies. The so-called cloud and so-called Internet are examples of a suitable communications network.

It should be appreciated that the configuration and network topology described herein has been dramatically simplified and that many more computing systems, software components, networks, servers, services, and networking devices can be utilized to interconnect the various computing systems disclosed herein and to provide the functionality described herein.

The remote source 160 connects to the computing system 102 via the one or more communications networks 104. The remote source 160 may be a computer or collection of computers that provide data and/or components (e.g., processor-executable instructions) to the computing system 102 via the one or more communications networks 104. For example, the remote source 160 may be an application store from which the computing system 102 may download the program modules that perform the functionalities of the technology described herein.

As depicted in FIG. 1, the computing system 102 includes multiple untrusted subsystems. The multiple untrusted subsystems include one or more central processing units (“CPUs”), which are called “processor(s)” 110 herein, a storage subsystem 112, a communications subsystem 114, an input/output subsystem 116, a main memory 120, an untrusted OS 130, a graphic processing unit (GPU) subsystem 140, and other subsystems 142.

The processor(s) 110 operates in conjunction with a chipset (not shown). The processor(s) 110 can be standard programmable processors that perform arithmetic and logical operations necessary for the operation of the computing system 102.

The computing system 102 includes a “motherboard,” which is a printed circuit board to which a multitude of the subsystems can be connected by way of a system bus or other electrical communication paths. The processor(s) 110 can be standard programmable processors that perform arithmetic and logical operations necessary for the operation of the computing system 102.

The processor(s) 110 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

As described herein, the computing system 102 may include one or more hardware processor(s) 110 configured to execute one or more stored instructions. The processor(s) 110 may comprise one or more cores. Further, the computing system 102 may include one or more network interfaces configured to provide communications between the computing system 102 and other devices, such as communications. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The chipset (not shown) may provide an interface between the processor(s) 110 and the remainder of the subsystems on the motherboard. The main memory 120 is a computer-readable storage medium for storing data 122 and applications. As depicted, application 124 is an example application stored in the main memory 120.

The main memory 120 may include read-only memory (“ROM”) and/or non-volatile RAM (“NVRAM”) for storing the data 122 and applications, such as application 124. The ROM or NVRAM can also store other applications and software components that facilitate the operation of the computing system 102 in accordance with the configurations described herein.

The application 124 may comprise any type of program or process to perform the techniques described in this disclosure performed by the computing system 102. An application may be described as a program product. An application is comprised of software components (or simply, “components”). A component being, for example, a set of executable instructions.

The computing system 102 can operate in a networked environment using logical connections to remote computing devices and computer systems through a network, such as one or more communications networks 104. The chipset can include functionality for providing network connectivity through the communications subsystem 114, such as a gigabit Ethernet adapter. The communications subsystem 114 is capable of connecting the computing system 102 to the remote source 160 and other computing devices over the one or more communications networks 104. It should be appreciated that multiple communications subsystems 114 can be present in the computing system 102, connecting the computing system 102 to other types of networks and remote computer systems.

The computing system 102 can be connected to the storage subsystem 112 that provides non-volatile storage for the computing system 102. The storage subsystem 112 can store the untrusted OS 130, application 124, and data 122. The storage subsystem 112 can be connected to the computing system 102 through a storage controller 514 connected to the chipset.

The storage subsystem 112 can consist of one or more physical storage units. The storage subsystem 112 can interface with the physical storage units through a serial attached SCSI (“SAS”) interface, a serial advanced technology attachment (“SATA”) interface, a fiber channel (“FC”) interface, or other types of interface for physically connecting and transferring data between computers and physical storage units.

The computing system 102 can store data on the storage subsystem 112 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage subsystem 112 is characterized as primary or storage, and the like.

For example, the computing system 102 can store information to the storage subsystem 112 by issuing instructions to the storage subsystem 112 to alter the magnetic characteristics of a particular location within a magnetic disk drive unit, the reflective or refractive characteristics of a particular location in an optical storage unit, or the electrical characteristics of a particular capacitor, transistor, or other discrete parts in a solid-state storage unit. Other transformations of physical media are possible without departing from the scope and spirit of the present description, with the foregoing examples provided only to facilitate this description. The computing system 102 can further read information from the storage subsystem 112 by detecting the physical states or characteristics of one or more particular locations within the physical storage units.

In addition to the storage subsystem 112 described above, the computing system 102 can have access to other computer-readable storage media to store and retrieve information, such as applications, program modules, data structures, or other data. It should be appreciated by those skilled in the art that computer-readable storage media is any available media that provides for the non-transitory storage of data, and that can be accessed by the computing system 102.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage subsystem 112 can store the untrusted OS 130 utilized to control the operation of the computing system 102. According to one embodiment, the operating system comprises the LINUX operating system. According to another embodiment, the operating system comprises the WINDOWS® SERVER operating system from MICROSOFT Corporation of Redmond, Wash. According to further embodiments, the operating system can comprise the UNIX operating system or one of its variants. It should be appreciated that other operating systems can also be utilized. The storage subsystem 112 can store applications, program modules, and data utilized by the computing system 102.

In one embodiment, the storage subsystem 112 or other computer-readable storage media is encoded with components (e.g., processor-executable instructions), which, when loaded into the computing system 102, transform the computing system 102 from a general-purpose computing system into a special-purpose computer capable of implementing the embodiments described herein. These components transform the computing system 102 by specifying how the processor(s) 110 transition between states, as described above.

The computing system 102 can also include the input/output subsystem 116 for receiving and processing input from several input devices, such as a keyboard, a mouse, a touchpad, a touch screen, an electronic stylus, or other types of input devices. Similarly, the input/output subsystem 116 can provide output to a display, such as a computer monitor, a flat-panel display, a digital projector, a printer, or other types of output devices.

The computing system 102 can also include GPU subsystem 140. The GPU subsystem is a specialized electronic circuit designed to rapidly manipulate and alter memory to accelerate the creation of images in a frame buffer intended for output to a display. The GPU subsystem 140 has computer architecture, much like the computing system 102 itself. However, the GPU subsystem 140 is specialized, both in function and form, to be very efficient at manipulating computer graphics and image processing. On the computing system 102, the GPU subsystem 140 may be present on a discrete removable/installable video card or embedded on the motherboard. In some instances, the GPU subsystem 140 is embedded on a die of the processor(s) 110.

The computing system 102 can also include other subsystems 142, such as a baseboard management controller (BMC) or an audio subsystem. A BMC is a small independent computing system inside a server. The BMC is a specialized built-in but an independent computing system that monitors the physical state of the server hardware and/or the functionality of the server's operating system.

The computing system 102 can also include the discrete TEE 150. The discrete TEE 150 includes a TEE processor(s) 152 and a TEE memory 154. Being discrete, the TEE processor(s) 152 and TEE memory 154 are physical hardware that is separate from and independent from the remainder of the computing system 102. That is, the processor(s) 110 and the TEE processor(s) 152 are physically distinct and separate processors. Likewise, the main memory 120 and the TEE memory 154 are physically distinct and separate memories.

The TEE 150 is a hardware-based secure enclave that addresses the problem of protecting data and applications while they are in use. With the TEE 150, TEE applications (such as TEE application 156) executes on TEE processor(s) 152 and using the TEE memory 154 in isolation from the untrusted subsystems of the computing system 102.

Herein, a discrete TEE may be described as the one or more processors 152 of the TEE 150 that is separate from and independent of processor(s) 110 of the computing system 102, and the TEE memory 154 of the TEE 150 is separate from and independent of the main memory 120 of the computing system 102. That is, the processor(s) 152 that execute the TEE application 156 of the TEE 150 is separate from and independent of the processor(s) 110 of the computing system 102. Similarly, the TEE memory 154 that stores the TEE data 162 and TEE application 156 may is separate from and independent of the main memory 120 of the computing system 102.

For ease of discussion, the processor(s) 110, the main memory 120, the untrusted OS 130, the storage subsystem 112, the communications subsystem 114, the input/output subsystem 116, the GPU subsystem 140, and the other subsystems 142 of the computing system 102 described herein as “untrusted” subsystems of the computing system 102.

While the computing system 102 hosts the discrete TEE 150, the TEE operates in isolation from the untrusted subsystems of the computing system 102. Thus, without the permission of the TEE 150, none of the untrusted subsystems of the computing system 102 can access the TEE 150 or any portion thereof. Indeed, the untrusted subsystems of the computing system 102 are described herein as “untrusted” because the TEE 150 does not trust them and is isolated therefrom.

The TEE processor(s) 152 operates in conjunction with its chipset (not shown) of the TEE 150. The TEE processor(s) 152 can be standard programmable processors that perform arithmetic and logical operations necessary for the operation of the TEE 150. Except for its isolation, the TEE processor(s) 152 may be of the same type used for the processor(s) 110. The TEE 150 may have its own “motherboard.”

The TEE processor(s) 152 may communicate with the untrusted subsystems of the computing system 102 so that the TEE 150 may take advantage of the functionality provided by such subsystems. However, such communication does not offer access to the TEE processor(s) 152 or TEE memory 154.

The TEE memory 154 is a computer-readable storage medium for storing TEE data 162 and TEE applications, such as TEE application 156. The TEE memory 154 may include read-only memory (“ROM”) and/or non-volatile RAM (“NVRAM”) for storing the data and applications. The ROM or NVRAM can also store other applications and software components that facilitate the operation of the TEE 150 in accordance with the configurations described herein.

The TEE application may comprise any type of program or process to perform the techniques described in this disclosure performed by the TEE 150. An application may be described as a program product. An application is comprised of software components (or simply, “components”). For instance, the application 124 may cause the computing system 102 to perform techniques to facilitate the TEE detection of systemic malware in the computing system 102 that hosts the tee.

As depicted in FIG. 1, the computer system 102 may have systemic malware 128 installed in memory and perhaps executing on the processor(s) 110. In other instances, the systemic malware 128 may be stored in the storage subsystem and/or another untrusted subsystem on the computing system 102. In other instances, the systemic malware 128 may be executed on or by one of the untrusted subsystems of the computing system 102.

The systemic malware 128 is an application or program module that is designed to cause damage, infiltrate, surveil, or otherwise access data, networks, or a subsystem of the computing system 102 without authorization and/or with harmful intent. As used herein, the modifier “systemic” specifically identifies malware stored on, executing on, or otherwise directed towards one or more of the subsystems of the computing system 102. Thus, a malware stored on, executing on, or otherwise directed towards some portion of the TEE 150 is not “systemic” malware, as the term is used herein.

Malware detection is a software tool that is designed to detect and remove systemic malware on a computer, like the computing system 102. Typically, malware detection involves scanning the files, memory, and other subsystems of the computing system 102. One of many techniques is typically used to accomplish malware detections. Such techniques include signature-based detection, heuristic behavioral analysis, and the like.

Signature-based detection looks for unique patterns in the executable program of the malware itself. These unique patterns act as a signature that identifies the malware. Heuristic behavioral analysis watches for suspicious behavior or patterns of behavior performed by a program. For example, access to the webcam may be suspicious or direct access to the storage subsystem that avoids the untrusted OS 130 may be suspicious. Such behavior may be blocked, or a user may be notified.

Conventional detection of the systemic malware 128 is performed by a systemic malware detection tool 126. As depicted, the systemic malware detection tool 126 is an application operating in the main memory 120 and processor(s) 110 of the computing system 102.

The conventional systemic malware detection tool 126 operates within the realm of the untrusted subsystems of the computing system 102 to detect malware within the realm of the untrusted subsystems of the computing system. Consequently, the conventional systemic malware detection tool 126 is subject to be fooled by malware that compromises some portion of the trusted subsystems of the computing system 102 and/or of the conventional systemic malware detection tool 126 itself.

For example, a systemic malware 128 may infect the untrusted OS 130 so that the OS intercepts data being transmitted to/from the conventional systemic malware detection tool 126. In this way, the infected OS 130 may mask the existence and behavior of the infecting systemic malware 128.

The technology described herein addresses those concerns. For example, the TEE 150 includes a systemic malware detection tool 158 operating therein. Like the systemic malware detection tool 126, the focus of the systemic malware detection tool 158 in the TEE 150 is the realm of the untrusted subsystems of the computing system 102. Thus, the systemic malware detection tool 158 is configured to detect malware such as systemic malware 128 in the main memory 120 of the computing system 102.

However, unlike the systemic malware detection tool 126, the systemic malware detection tool 158 operates outside of the realm of the untrusted subsystems of the computing system 102. Indeed, the systemic malware detection tool 158 operates in isolation from and away from the influence of the untrusted subsystems of the computing system 102. Consequently, no systemic malware can affect, influence, change or interfere with the operation of the systemic malware detection tool 158 in the TEE.

Occasionally, the systemic malware detection tool 158 itself, associated data, and/or malware signature database may need to be updated. This may be accomplished by the TEE 150 downloading an update 164 from a remote source 160. The update 164 may include, for example, patches to fix, improve, or upgrade the operation of the systemic malware detection tool 158 or the latest malware signatures.

Since the TEE 150 operates independently of the untrusted subsystems of the computing system 102, the TEE 150 may request and download the update 164 from the remote source 160 without the cooperation or permission of any of the untrusted subsystems of the computing system. In particular, the TEE 150 does not seek the cooperation of the permission of the untrusted OS 130. Because of this, an infected subsystem cannot interfere or infect the update operation of the systemic malware detection tool 158 of the TEE 150.

While the TEE 150 operates independently as stated, the TEE 150 does direct or interact with some of the subsystems. For example, the TEE 150 interacts with the communication subsystem 114 to perform the communication with the remote source 160. However, in these instances, the TEE 150 performs these interactions directly without the involvement of the untrusted OS 130.

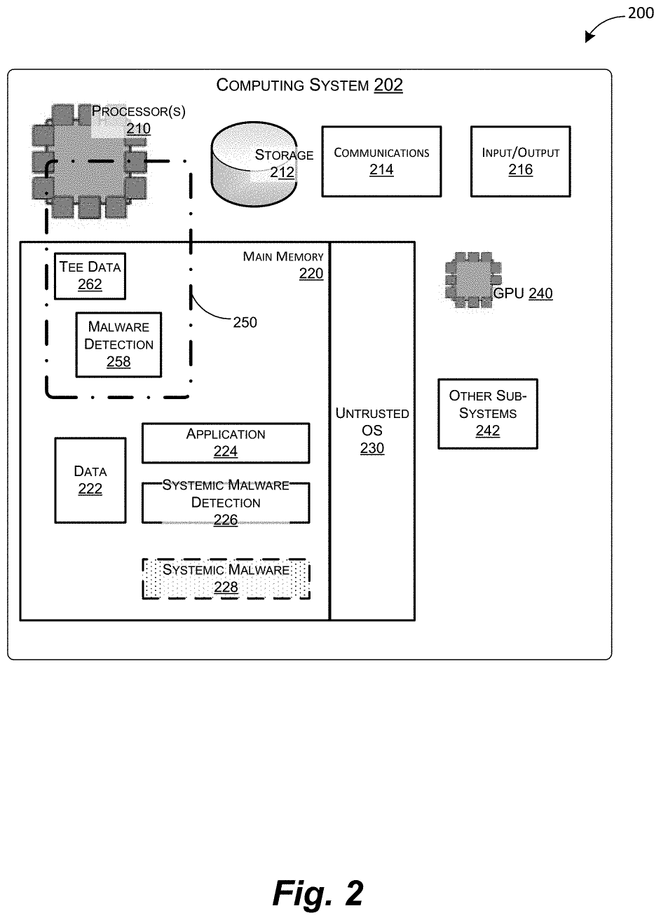

FIG. 2 schematically illustrates an example scenario 200 in accordance with the technology described herein. In particular, the example scenario 200 depicts a computing system 202 that hosts an integrated TEE 250. While not depicted, the computing system 202 of the example scenario 200 may connect to one or more communications networks, like networks 104, and a remote source, like remote source 160.

The computing system 202 is much like the computing system 102. The computing system 202 includes multiple untrusted subsystems, such as processor(s) 210, a storage subsystem 212, a communications subsystem 214, an input/output subsystem 216, a main memory 220, an untrusted OS 230, a GPU subsystem 240, and other subsystems 242. The functioning and interrelationships of the subsystems of the computing system 202 is largely the same as the subsystems of the computing system 102.

For ease of discussion, the processor(s) 210, main memory 220, untrusted OS 230, the storage subsystem 212, the communications subsystem 214, the input/output subsystem 216, the GPU subsystem 240, and the other subsystems 242 of the computing system 202 described herein as “untrusted” subsystems of the computing system 202.

Unlike the computing system 102, the computing system 202 hosts a TEE that is integrated rather than discrete. That is, the TEE 250 is integrated into and with the processor 210 and main memory 220 of the computing system 202.

Unlike a discrete TEE (such as TEE 150), the integrated TEE 250 does not have its dedicated physical processors (e.g., TEE processors 152) and memory (e.g., TEE memory 154). Instead, the integrated TEE 250 shares a functional portion of the processor(s) 210 and the main memory 220 of the computing system 202.

The functional partition of the integrated TEE 250 is created and enforced by hardware-level functions built into the processor(s) 210 and/or the main memory 220. Often the data and applications of the TEE 250 are encrypted when stored in the main memory 220 and only decrypted while being used by the processor(s) 210. Thus, TEE data 262 and TEE applications are completely protected from the subsystems, the untrusted OS 230, a hypervisor, and a root user of a compromised computing system, such as the computing system 202.

Using the hardware-level isolation functionality of the processor(s) 210 and/or main memory 220, the integrated TEE 250 may execute TEE applications and store TEE data 262 in isolation from the untrusted subsystems of the computing system 202. While the computing system 202 hosts the TEE 250, the TEE operates in isolation from the untrusted subsystems of the computing system 202. Thus, none of the untrusted subsystems of computing system 202 can access the integrated TEE 250 or any portion thereof. Indeed, the untrusted subsystems of the computing system 202 are described herein as “untrusted” because the TEE 250 does not trust them and is isolated therefrom.

Herein, an integrated TEE may be described as one or more processors of the TEE 250 being co-extensive with one or more processors of the computing system 202, and the memory of the TEE 250 is co-extensive with and a portion of a main memory 220 of the computing system 202. That is, the processor(s) that execute the TEE applications of the TEE 250 may be the same as or a part of the processor(s) 210 of the computing system 202. Similarly, the memory that stores the TEE data 262 and TEE applications may be a portion of the main memory 220 of the computing system 202.

As depicted in FIG. 2, the computer system 202 may have systemic malware 228 installed in the main memory 220 and perhaps executing on the processor(s) 210. In other instances, the systemic malware 228 may be stored in the storage subsystem and/or another untrusted subsystem on the computing system 202. In other instances, the systemic malware 228 may be executed on or by one of the untrusted subsystems of the computing system 202.

The systemic malware 228 is like the systemic malware 128 described above. Conventional detection of systemic malware 228 may be performed by a systemic malware detection tool 226. As depicted, the systemic malware detection tool 226 is an application operating in the main memory 220 and processor(s) 210 of the computing system 202, but not in isolation for the untrusted subsystems of the computing system 202.

The conventional systemic malware detection tool 226 operates within the realm of the untrusted subsystems of the computing system 202 to detect malware within the realm of the untrusted subsystems of the computing system. Consequently, the conventional systemic malware detection tool 226 is subject to be fooled by malware that compromises some portion of the trusted subsystems of the computing system 202 and/or of the conventional systemic malware detection tool 226 itself.

For example, a systemic malware 228 may infect the untrusted OS 230 so that the OS intercepts data being transmitted to/from the conventional systemic malware detection tool 226. In this way, the infected OS 230 may mask the existence and behavior of the infecting systemic malware 228.

The technology described herein addresses those concerns. For example, the integrated TEE 250 includes a systemic malware detection tool 258 operating therein. Like the systemic malware detection tool 226, the focus of the systemic malware detection tool 258 in the TEE 250 is the realm of the untrusted subsystems of the computing system 202. Thus, the systemic malware detection tool 258 is configured to detect malware such as systemic malware 228 in the main memory 220 of the computing system 202.

However, unlike the systemic malware detection tool 226, the systemic malware detection tool 258 operates outside of the realm of the untrusted subsystems of the computing system 202. Indeed, the systemic malware detection tool 258 operates in isolation from and away from the influence of the untrusted subsystems of the computing system 202. Consequently, no systemic malware can affect, influence, change or interfere with the operation of the systemic malware detection tool 258 in the TEE.

Occasionally, the systemic malware detection tool 258 itself, associated data, and/or malware signature database may need to be updated. This may be accomplished by the TEE 250 downloading an update (not shown, but much like update 164) from a remote source (not shown, but much like remote source 160).

It will be appreciated that the computing systems 102 and 202 might not include all of the subsystems and parts, as shown in FIGS. 1 and 2, can include other subsystems and parts that are not explicitly shown in FIGS. 1 and 2, or might utilize an architecture completely different than that shown in FIGS. 1 and 2.

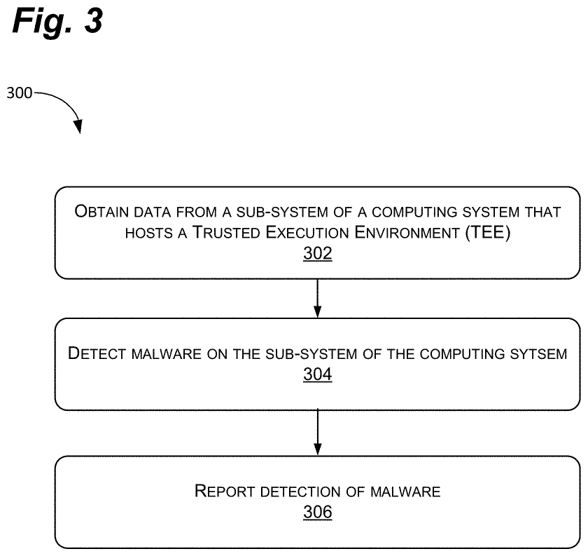

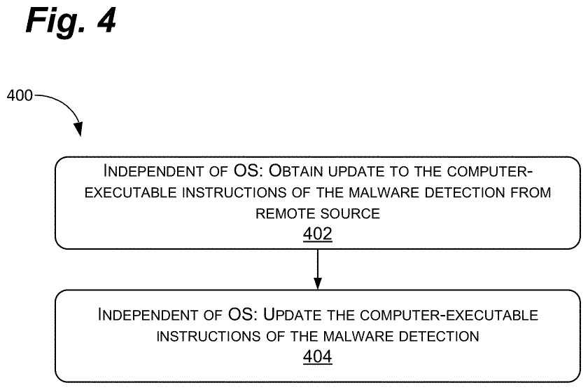

According to one embodiment, the TEEs 150 and 250 have access to computer-readable storage media storing components (e.g., processor-executable instructions), which, when executed by the TEEs 150 and 250, perform the process described above with regard to FIGS. 3 and 4. The TEEs 150 and 250 can also include computer-readable storage media having instructions stored thereupon for performing any of the other computer-implemented operations described herein.

FIGS. 3 and 4 illustrate example processes in accordance with embodiments of the disclosure. These processes are illustrated as logical flow graphs, each operation of which represents a sequence of operations that can be implemented in hardware, software, or a combination thereof. In the context of software, the operations represent processor-executable instructions stored on one or more computer-readable storage media that, when executed by one or more processors, perform the recited operations. Generally, processor-executable instructions include routines, programs, objects, components, data structures, and the like that perform particular functions or implement particular abstract data types. In some instances, processor-executable instructions may be called computer-executable instructions. The order in which the operations are described is not intended to be construed as a limitation, and any number of the described operations can be omitted or combined in any order and/or in parallel to implement the processes.

FIG. 3 illustrates an example process 300 for the detection of systemic malware in computing systems from a TEE. For illustration purposes, the example process 300 is described as being performed by an example TEE. This example TEE may be, for example, the discrete TEE 150 hosted by the computing system 102 or the integrated TEE 250 hosted the computing system 202.

At operation 302, the example TEE obtains data from an untrusted subsystem of a computing system—such as computing system 102 or 202—the hosts the example TEE. Examples of an untrusted subsystem include an OS, applications executing on the computing system, storage subsystem of the computing system, memory of the computing system, graphics processing subsystem of the computing system, baseboard management controller, and other subsystems of the computing system.

The example TEE is configured to execute components in isolation from the untrusted subsystems of the computing system. That is, the execution environment (e.g., executing TEE applications and TEE data) operates away from the influence of the untrusted subsystems of the computing system. Thus, without the permission of the example TEE, none of the untrusted subsystems of the computing system can access the TEE data, TEE applications, and runtime state of the example TEE or any portion thereof.

At operation 304, the example TEE, based on the data obtained, detects malware one or more of the untrusted subsystems of the computing system.

A TEE application is designed to detect malware executes in the example TEE. This malware detection application detects and removes systemic malware on the computing system. This malware detection may involve scanning the files, memory, and other subsystems of the computing system. One of many techniques may be employed to accomplish systemic malware detection. Such techniques include signature-based detection, heuristic behavioral analysis, and the like.

Operations 302 and 304 are performed independently and out-of-band of an untrusted OS of the computing system. That is, operations 302 and 304 do not need or use the cooperation or permission of the untrusted central processors or untrusted OS to perform the systemic malware detection. Similarly, systemic malware detection may be updated without the cooperation or permission of the untrusted central processors or untrusted OS.

At operation 306, in response to detected systemic malware, the example TEE reports the detection of malware on the one or more untrusted subsystems of the computing system. This report may be an on-screen notification to a user, a notification to the OS, a message sent across the communication network, and the like.

In addition, the example TEE may take active steps to ameliorate the malware. For example, the example TEE may “sandbox” the detected malware. That is, the example TEE may isolate the execution of the malware in order to test it further. In other instances, the example TEE may attempt to irradiate or remove the malware. In still other instances, the example TEE may attempt to neuter or disarm the malware.

FIG. 4 illustrates an example process 400 for the detection of systemic malware in computing systems from a TEE. For illustration purposes, the example process 400 is described as being performed by an example TEE. This example TEE may be, for example, the discrete TEE 150 hosted by the computing system 102 or the integrated TEE 250 hosted the computing system 202.

At operation 402, the example TEE obtains updates to the components (e.g., processor-executable instructions) of the TEE application that performs the systemic malware detection from a remote source on the communications network.

At operation 404, the example TEE updates the components of operations 302, 304, and/or 306 with the updates.

Operations 402 and 404 are performed independently and out-of-band of the untrusted OS of the computing system. That is, operations 402 and 404 do not need or use the cooperation or permission of the untrusted central processors or untrusted OS to perform the systemic malware detection. Similarly, systemic malware detection may be updated without the cooperation or permission of the untrusted central processors or untrusted OS.

The example TEE of FIGS. 3 and 4 may be either an integrated, discrete, or a combination of both types of TEE. Herein, an integrated TEE may be described as a TEE having one or more processors that are co-extensive with one or more processors of the computing system and the TEE having the memory that is co-extensive with and a portion of a main memory of the computing system. Herein, a discrete TEE may be described as a TEE having one or more processors that are physically separate from and independent of one or more processors of the computing system and the TEE having a memory that is physically separate from and independent of a main memory of the computing system.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

What is claimed is:

1. A trusted execution environment (TEE) comprising:
one or more processors;
a memory; and
one or more components stored in the memory and executable by the one or more processors to perform operations comprising:
obtaining data from one or more subsystems of a computing system that hosts the TEE, wherein the TEE is configured to execute components in isolation from the one or more subsystems of the computing system;
based on the data obtained, detecting malware on the one or more subsystems of the computing system; and
in response to detected malware, reporting detection of malware on the one or more subsystems of the computing system.

2. The TEE of claim 1, wherein the obtaining and detecting are performed independently of an untrusted operating system (OS) of the computing system.

3. The TEE of claim 1 further comprising:
obtaining an update to the one or more components from a remote source; and
updating the one or more components with the update,
wherein the obtaining of the update and the updating are performed independently of an untrusted operating system (OS) of the computing system.

4. The TEE of claim 1, wherein the one or more subsystems of the computing system are selected from a group consisting of an operating system (OS), applications executing on the computing system, a storage subsystem of the computing system, a memory of the computing system, a graphics processing subsystem of the computing system, and a baseboard management controller.

5. The TEE of claim 1, wherein the computing system is selected from a group consisting of a computer, a mobile device, a server, a tablet computer, a notebook computer, a handheld computer, a workstation, a desktop computer, a laptop, a tablet, a user equipment (UE), a network appliance, an e-reader, a wearable computer, a network node, a microcontroller, and a smartphone.

6. The TEE of claim 1, wherein the one or more processors of the TEE is co-extensive with one or more processors of the computing system and the memory of the TEE is co-extensive with and a portion of a main memory of the computing system.

7. The TEE of claim 1, wherein the one or more processors of the TEE is separate from and independent of one or more processors of the computing system and the memory of the TEE is separate from and independent of a main memory of the computing system.

8. A method comprising:
obtaining data from one or more subsystems of a computing system, the computing system hosting a trusted execution environment (TEE) configured to execute components in isolation from the one or more subsystems of the computing system;
based on the data obtained, detecting malware on the one or more subsystems of the computing system; and
in response to detected malware, reporting detection of malware on the one or more subsystems of the computing system.

9. The method of claim 8, wherein the obtaining and detecting are performed independently of an untrusted operating system (OS) of the computing system.

10. The method of claim 8 further comprising:
obtaining an update to the components from a remote source; and
updating the components with the update,
wherein the obtaining the update and the updating are performed independently of an untrusted operating system (OS) of the computing system.

11. The method of claim 8, wherein the one or more subsystems of the computing system are selected from a group consisting of an operating system (OS), applications executing on the computing system, a storage subsystem of the computing system, a memory of the computing system, a graphics processing subsystem of the computing system, and a baseboard management controller.

12. The method of claim 8, wherein the computing system is selected from a group consisting of a computer, a mobile device, a server, a tablet computer, a notebook computer, a handheld computer, a workstation, a desktop computer, a laptop, a tablet, a user equipment (UE), a network appliance, an e-reader, a wearable computer, a network node, a microcontroller, and a smartphone.

13. The method of claim 8, wherein the one or more processors of the TEE are co-extensive with one or more processors of the computing system and a memory of the TEE is co-extensive with and a portion of a main memory of the computing system.

14. The method of claim 8, wherein the one or more processors of the TEE are separate from and independent of one or more processors of the computing system and a memory of the TEE is separate from and independent of a main memory of the computing system.

15. One or more non-transitory computer-readable media storing processor-executable instructions that, when executed by one or more processors, cause the one or more processors to perform operations comprising:
obtaining data from one or more subsystems of a computing system, the computing system hosting a trusted execution environment (TEE) configured to execute processor-executable instructions in isolation from the one or more subsystems of the computing system;
based on the data obtained, detecting malware on the one or more subsystems of the computing system; and
in response to detected malware, reporting detection of malware on the one or more subsystems of the computing system.

16. One or more non-transitory computer-readable media of claim 15, wherein the obtaining and the detecting are performed independently of an untrusted operating system (OS) of the computing system.

17. One or more non-transitory computer-readable media of claim 15 further comprising:
obtaining an update to the processor-executable instructions from a remote source; and
updating the processor-executable instructions with the update,
wherein the obtaining the update and the updating are performed independently of an untrusted operating system (OS) of the computing system.

18. One or more non-transitory computer-readable media of claim 15, wherein the one or more subsystems of the computing system are selected from a group consisting of an operating system (OS), applications executing on the computing system, a storage subsystem of the computing system, a memory of the computing system, a graphics processing subsystem of the computing system, and a baseboard management controller.

19. One or more non-transitory computer-readable media of claim 15, wherein the one or more processors of the TEE are co-extensive with one or more processors of the computing system and a memory of the TEE is co-extensive with and a portion of a main memory of the computing system.

20. One or more non-transitory computer-readable media of claim 15, wherein the one or more processors of the TEE are separate from and independent of one or more processors of the computing system and a memory of the TEE is separate from and independent of a main memory of the computing system.
